(19) United States
(12) Patent Application Publication
(10) Pub. No.: US 2023/0056460 A1
(43) Pub. Date: Feb. 23, 2023

(54) BRIGHTNESS CONTROLS FOR DUAL-SIDED DISPLAYS

(71) Applicant: Hewlett-Packard Development Company, L.P., Spring, TX (US)

(72) Inventors: Hsing-Hung Hsieh, Taipei City (TW); Super Liao, Taipei City (TW); Alan Man Pan Tam, Spring, TX (US)

(73) Assignee: Hewlett-Packard Development Company, L.P., Spring, TX (US)

(21) Appl. No.: 17/795,023

(22) PCT Filed: Feb. 14, 2020
(86) PCT No.: PCT/US2020/018226

§ 371 Date: Jul. 25, 2022

(51) Int. Cl. G06F 3/14; G09G 3/34; G09G 3/36

(52) U.S. Cl. CPC G06F 3/1423; G09G 3/3426; G09G 3/3611; G09G 2300/023; G09G 2320/064

(57) ABSTRACT

In example implementations, a display is provided. The display includes a backlight unit (BLU), a first display panel, a second display panel, and a controller. The BLU includes a first side and a second side. The first display panel includes a first layer of liquid crystals and is coupled to the first side of the BLU. The second display panel includes a second layer of liquid crystals and is coupled to the second side of the BLU. The controller is to set the BLU to a brightness level associated with a first brightness setting of the first display panel and to control the second layer of liquid crystals to set a second brightness setting of the second display panel.

### BACKGROUND

Displays can be used to produce visible images. Displays have evolved over time from cathode ray tube (CRT) based displays to light emitting diode (LED) based displays and organic LED (OLED) displays. The LED and OLED displays provide a smaller and lighter display that is more energy efficient than CRT based displays.

Previous displays can produce a visible image in a single direction. Thus, users may generally sit together on a side in which the image is projected in the display. If users are sitting across from one another, the display may be rotated to allow both users to view the image.

### BRIEF DESCRIPTION OF THE DRAWINGS

FIG. 1 is a block diagram of an example dual-sided display of the present disclosure;

FIG. 2 is a block diagram of an example cross-sectional view of the dual-sided display of the present disclosure;

FIG. 3 is a block diagram of an example backlight unit of the present disclosure;

FIG. 4 is a block diagram of an example of the dual-sided display with independent brightness controls for each display of the present disclosure;

FIG. 5 is a flow chart of an example method for independently controlling a brightness of each display of the dual-sided display of the present disclosure; and

FIG. 6 is a block diagram of an example non-transitory computer-readable storage medium storing instructions executed by a processor to control a brightness of each display in a dual-sided display of the present disclosure.

### DETAILED DESCRIPTION

Examples described herein provide brightness controls for dual-sided displays. As discussed above, previous displays may provide an image in a single direction. Thus, for users to view the image, the users may sit together on one side of the display, or the display may be rotated or moved to allow other users to view the image.

In contrast, dual-sided displays allow users to sit opposite one another and see the image from both sides of the display. For example, users may sit across from one another, and each user may see his or her own image on a respective side of the dual-sided display.

Current dual-sided displays use two liquid crystal displays (LCDs) that are stacked back-to-back. However, this design may cause the form factor of the display to be too thick or cumbersome.

The present disclosure provides a dual-sided display that uses a single backlight unit for both sides and a method to independently control the brightness of each side of the dual-sided display that has a single backlight unit. For example, the backlight unit may be set to a brightness associated with a display that uses a higher brightness setting. The other display with a lower brightness setting may be controlled by the liquid crystals. As a result, the brightness can be independently controlled for both displays in a dual-sided display having a single backlight unit.

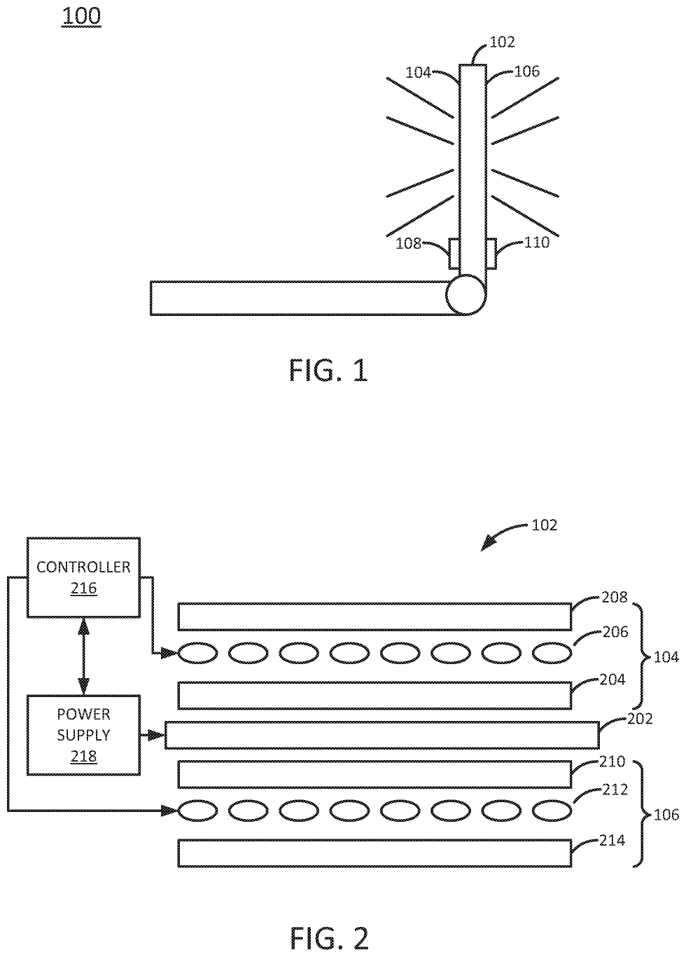

FIG. 1 illustrates an example apparatus 100 that includes a dual-sided display 102. In an example, the apparatus 100 may be a laptop or tablet device. In another example, the apparatus 100 may be a stand-alone display or monitor.

In an example, the dual-sided display 102 may be capable of displaying images on opposite sides. For example, the dual-sided display may have a first display or display panel 104 that displays an image in a first direction and a second display or display panel 106 that may display an image in a second direction. The first display 104 and the second display 106 may be opposite one another and display images in opposite directions. The images displayed by the first display 104 and the second display 106 may be the same image or different images. As a result, two users may sit opposite one another and view the first display 104 and the second display 106, respectively.

In an example, the first display 104 may include a first brightness control interface 108 and the second display 106 may include a second brightness control interface 110. The first brightness control interface 108 may be a physical button or an on-screen display shown on the first display 104 that allows the brightness of the first display 104 to be set. The second brightness control interface 110 may be a physical button or an on screen display shown on the second display 106 that allows the brightness of the second display 106 to be set. Thus, the brightness of the first display 104 and the second display 106 may be independently controlled and set to different brightness levels.

In an example, the dual-sided display 102 may be a liquid crystal display (LCD) that has a single backlight unit (BLU). For example, the first display 104 may be a first liquid crystal display panel and the second display 106 may be a second liquid crystal display panel. The present disclosure provides a method to independently control the brightness of the first display 104 and the second display 106 despite sharing the same BLU, as discussed in further details below.

FIG. 2 illustrates an example cross-sectional view of the dual-sided display 102. In an example, the dual-sided display 102 may have a single BLU 202 that emits light that is used to generate images that are displayed by the first display 104 and the second display 106. The BLU 202 may include light emitting diodes (LEDs) or arrays of LEDs to generate light.

In an example, the first display 104 may include a thin film transistor (TFT) layer 204, a layer of liquid crystals 206, and a color filter layer 208. In an example, the second display 106 may include a TFT layer 210, a layer of liquid crystals 212, and a color filter layer 214. The TFT layer 204, the liquid crystals 206, and the color filter layer 208 of the first display 104 and the TFT layer 210, the layer of liquid crystals 212, and the color filter layer 214 of the second display 106 may be located on opposite sides of the BLU 202. In other words, the BLU 202 may be located between the TFT layer 204, the liquid crystals 206, and the color filter layer 208 of the first display 104 and the TFT layer 210, the layer of liquid crystals 212, and the color filter layer 214 of the second display 106.

In an example, the TFT layers 204 and 210 may be used to control each pixel of the displays 104 and 106, respectively. Thus, by having two separate TFT layers 204 and 210, the first display 104 may be capable of displaying a different image than the second display 106.

In an example, the layers of liquid crystals 206 and 212 may include liquid crystals that can be controlled by an applied voltage. The orientation of the liquid crystals in the layers of liquid crystals 206 and 212 is controlled by electric current applied by a power supply 218. The orientation of the liquid crystals can determine how light emitted by the BLU 202 exits through the first display 104 and the second display 106. The liquid crystals can orient themselves in accordance with a direction of the electric current that passes through the liquid crystals.

Based on the how the liquid crystals are moved or rotated, different amounts of light emitted by the BLU 202 may pass through the layers of liquid crystals 206 and 212. For example, in certain orientations, the light emitted by the BLU 202 may pass through the layers of liquid crystals 206 and 212. Thus, the first display 104 or the second display 106 may appear to have a first level of brightness. In other orientations, some of the light emitted by the BLU 202 may be reflected back towards the BLU 202. Thus, the first display 104 or the second display 106 may appear to have a second level of brightness. Thus, the rotation or movement of the liquid crystals in one of the layers of liquid crystals 206 or 212 may be used to control the brightness of one of the displays 104 or 106, as discussed in further details below.

The color filter layers 208 and 214 may control the color of the light emitted by each pixel. For example, the color filter layers 208 and 214 may emit light in red, green, and blue, or any combination thereof, to generate different colors for each pixel for a particular image that is displayed.

In an example, the dual-sided display 102 may include a power supply 218 and a controller 216. In an example, the controller 216 may be communicatively coupled to the power supply 218 and the layers of liquid crystals 206 and 212. In an example, the controller 216 may be communicatively coupled to a power supply (not shown) connected to the layers of liquid crystals 206 and 212. In an example, the controller 216 may be a processor or an application specific integrated circuit (ASIC). The controller 216 may execute instructions stored in memory to perform the functions described herein or may be programmed (e.g., in the case of an ASIC) to perform a function.

In an example, the power supply 218 may control a brightness of the BLU 202. For example, the power supply 218 may be operated as a pulse width modulation (PWM) power supply and provide power in pulses to the BLU 202. The pulses may turn the BLU 202 on and off. A ratio of how long the BLU 202 stays on or off may determine a brightness of the displays 104 and 106 that is perceived by a user. For example, the power supply 218 may turn the BLU 202 on 80% of the time and off 20% of the time for a first level of brightness. The power supply 218 may turn the BLU 202 on 60% of the time and off 40% of the time for a second level of brightness that is lower than the first level of brightness. The time period of the pulses may be controlled by the controller 216 based on a requested level of brightness for the displays 104 and 106.

In an example, the controller 216 may also control the rotation of the liquid crystals inside of the layers of liquid crystals 206 and 212. The controller 216 may control the rotation of the liquid crystals in the layer of liquid crystals 206 independent from the layer of liquid crystals 212. As discussed in further details below, the combination of the controlling the brightness of the BLU 202 and the rotation of the liquid crystals in the layers of liquid crystals 206 or 208 may be used to independently control the brightness of the displays 104 and 106 despite sharing a single BLU 202.

Furthermore, the example dual-sided display 102 may have an overall thickness or profile that is thinner than other dual-sided displays, since the dual-sided display 102 uses a single BLU 202. In addition, the example dual-sided display 102 may have a relatively lower overall energy consumption than other dual-sided displays by using a single BLU 202.

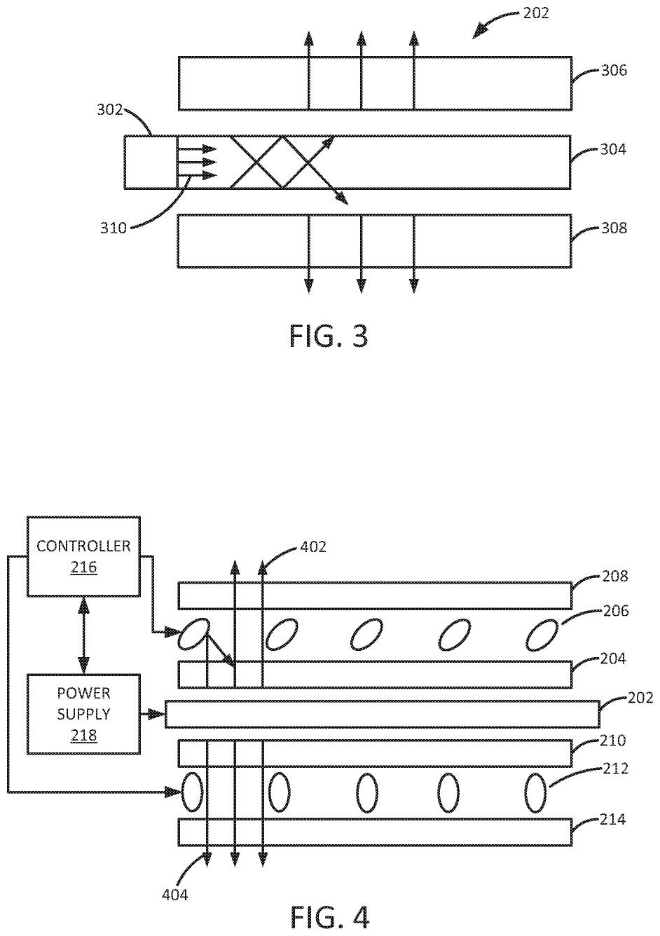

FIG. 3 illustrates an example of the BLU 202 that can be used for the dual-sided display 102. It should be noted that the BLU 202 can be implemented in other ways and that FIG. 3 provides one possible example.

In an example, the BLU 202 may include a light source 302 to generate light 310. For example, the light source 302 can be an LED or an array of LEDs. The light source 302 may be coupled to a light guide 304. The light source 302 may emit light 310 that propagates into the light guide 304.

In an example, the LEDs of the light source 302 may emit the light 310 at varying angles in a hemispheric pattern that is scattered through the light guide 304. The light guide 304 may be an optically clear component that uses total internal reflection. Some of the light 310 may be scattered down along a length of the light guide 304 via total internal reflection (e.g., light emitted or reflected at a critical angle of the light guide 304). However, some of the light 310 may be scattered or reflected at angles that allow the light 310 to escape on both sides of the light guide 304.

In an example, the BLU 202 may also include optical components 306 and 308 on opposite sides of the BLU 202. In an example, the optical components 306 and 308 may diffract the light 310 towards the layers of the first display 104 and the second display 106 illustrated in FIG. 2, and discussed above. The optical components 306 may include diffusers, prism sheets, and the like, to control a direction of the light 310 emitted from respective sides of the light guide 304.

FIG. 4 illustrates an example cross-sectional view of the dual-sided display 102 and how the brightness of the first display 104 and the second display 106 can be independently controlled. In other words, despite using a single BLU 202, the brightness of the first display 104 may be different than the brightness of the second display 106.

In an example, the controller 216 may receive a first brightness level for the first display 104 and a second brightness level for the second display 106. The controller 216 may be communicatively coupled to a first brightness control interface 108 and a second brightness control interface 110, illustrated in FIG. 1. As discussed above, the brightness control interfaces 108 and 100 may be on screen display menus or physical buttons that can be used to toggle the brightness. For example, the first display 104 and the second display 106 may have separate on screen displays that allow a user to set a brightness level. In another example, physical buttons may be deployed on the first display 104 and the second display 106 to toggle the brightness level for the first display 104 and the second display 106.

The controller 216 may compare the first brightness level and the second brightness level to determine a higher brightness level. The controller 216 may then control the power supply 218 to provide a power level to set the brightness of the BLU 202 to the higher brightness level. The controller may then rotate the liquid crystals in the layer of liquid crystals 206 or 212 with the lower brightness level to adjust the brightness level to the lower brightness level.

For example, in FIG. 4, the brightness level of the second display 106 may be determined to be higher than the brightness level of the first display 104. As a result, the controller 216 may rotate the liquid crystals in the layer of liquid crystals 212 to be rotated or moved to a position to allow a maximum amount of light to pass through. As illustrated in FIG. 4, light rays 404 may pass through the layer of liquid crystals 212.

The controller 216 may then control the power supply 218 to provide enough power to the BLU 202 to generate a brightness equal to the requested brightness level of the second display 106. As a result, the brightness level of the second display 106 may be set.

The controller 216 may then calculate an amount of rotation or movement of the liquid crystals in the layer of liquid crystals 206 to reduce the brightness by an amount to achieve the requested brightness level of the first display 104. For example, different orientations of the liquid crystals in the layers of liquid crystals 206 and 212 can allow different amounts of light to pass through. The different amounts of light that can pass through may be associated with different brightness levels. In addition, the different orientations of the liquid crystals can be controlled by an amount of electric current that is applied by the power supply 218. The different orientations of the liquid crystals at different amounts of electric current to achieve a particular level of brightness may be predetermined. The association of electric current and a particular level of brightness can be stored in memory.

For example, it may be predefined that a rotation of 1 degree of the liquid crystal may equate to an approximately 1 percent reduction in brightness, and so forth. Thus, to reduce the brightness by 40 percent, the controller 216 may determine that the liquid crystals should be rotated by 40 degrees. It should be noted that the values are provided as examples and should not be considered limiting.

Thus, when a brightness level is requested, the controller 216 may access the memory to obtain the amount of electric current to apply to the liquid crystals in the layer of liquid crystals 206. The liquid crystals in the layer of liquid crystals 206 can be rotated into a particular orientation. As illustrated in FIG. 4, some light 402 can be reflected back towards the BLU 202 when the liquid crystals are rotated. Since less light 402 passes through the layer of liquid crystals 206, the first display 104 may appear to have a lower brightness than the second display 106.

For example, if the brightness of the second display 106 was 500 nits and the brightness of the first display 104 is 300 nits, then the liquid crystals in the layer of liquid crystals 206 may be rotated to reduce the brightness by 40% (e.g., 200 nits dimmer than 500, or 200/500×100%=40%). Thus, FIG. 4 illustrates that the liquid crystals in the layer of liquid crystals 206 are rotated to reduce the brightness of first display 104.

The controller 216 may dynamically adjust the brightness levels of the first display 104 and the second display 106 as the user changes the desired brightness levels. For example, the brightness level of the second display 106 may be initially set to be brighter than the brightness level of the first display 104. Then the brightness level of the first display 104 may be set to be higher than the brightness level of the second display 106. As a result, the controller 216 may set the power provided to the power supply 218 to control the brightness of the BLU 202 to be equal the brightness level of the first display 104. The controller 216 may then control the liquid crystals in the layer of liquid crystals 206 via an electric current into an orientation that allows a maximum amount of light through the layer of liquid crystals 206. The controller 216 may calculate an amount of reduction for the brightness level of the second display 106 and control the orientation of the liquid crystals in the layer of liquid crystals 212 accordingly.

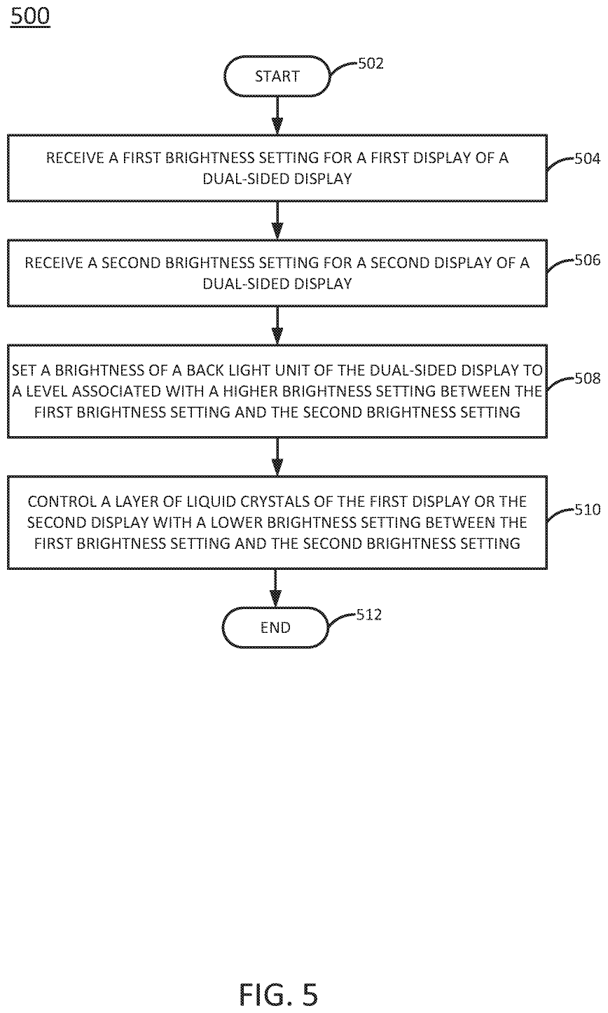

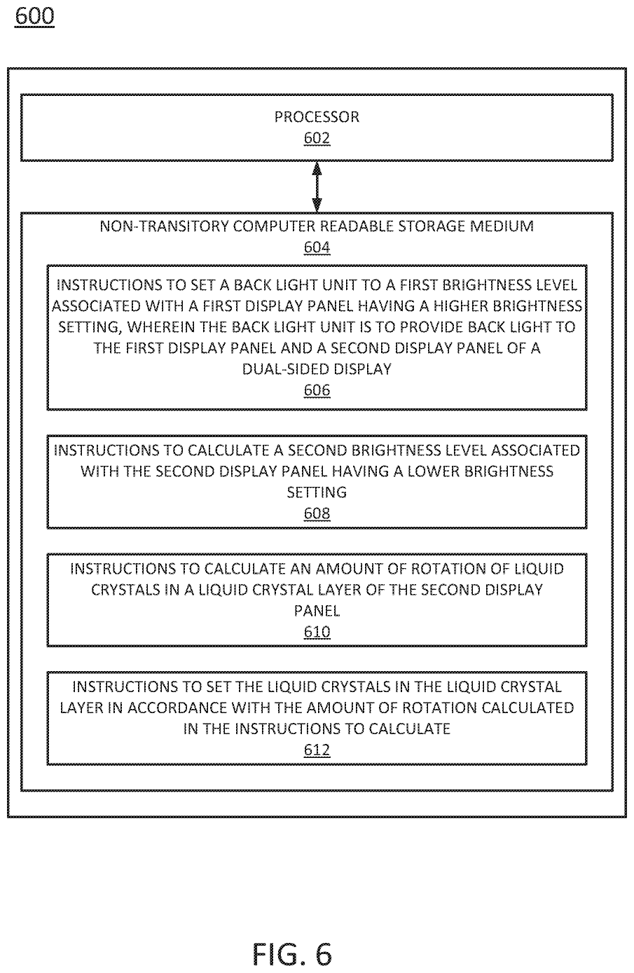

FIG. 5 illustrates a flow diagram of an example method 500 for independently controlling a brightness of each display of the dual-sided display of the present disclosure. In an example, the method 500 may be performed by the apparatus 100, the controller 216 of the dual-sided display 102, or the apparatus 600 illustrated in FIG. 6, and described below.

At block 502, the method 500 begins. At block 504, the method 500 receives a first brightness setting for a first display of a dual-sided display. For example, a first user viewing the first display may desire a particular brightness level. The first user may select the first brightness setting via an on screen display of the first display or physical buttons that can be used to toggle the brightness of the first display.

At block 506, the method 500 receives a second brightness setting for a second display of the dual-sided display. For example, a second user viewing the second display may desire a particular brightness level. The second user may select the second brightness setting via an on screen display of the second display or physical buttons that can be used to toggle the brightness of the second display.

At block 508, the method 500 sets a brightness of a backlight unit of the dual-sided display to a level associated with a higher brightness setting between the first brightness setting and the second brightness setting. For example, the first brightness setting and the second brightness setting may be compared to determine the higher brightness setting and the lower brightness setting. The backlight unit of the dual-sided display may be set to have a brightness that is approximately equal to the higher brightness setting. For example, a pulse width modulation power supply may provide an amount of power and at an associated time period to set a brightness of the backlight unit to be approximately equal to the higher brightness setting.

At block 510, the method 500 controls a layer of liquid crystals of the first display or the second display with a lower brightness setting between the first brightness setting and the second brightness setting. For example, the display with the lower brightness setting may have the liquid crystals in the layer of liquid crystals rotated to allow a desired amount of light that is associated with the lower brightness setting to pass through.

To illustrate, after the block 508 was performed, the method 500 may determine that the first display had the higher brightness setting and the second display had the lower brightness setting. The liquid crystals in the layer of liquid crystals of the first display may be set to a full on position. The BLU may be set to a brightness level that is approximately equal to the higher brightness setting.

The liquid crystals in the layer of liquid crystals of the second display may be rotated to prevent some of the light from the BLU from passing through. The amount of rotation or movement of the liquid crystals may be a function of a percentage, or difference, of the higher brightness level and the lower brightness level. The amount of light that passes through for a certain amount of rotation may be predetermined. Thus, the liquid crystals may be rotated by an amount that is approximately equal to the percentage or amount of light that should be blocked to achieve the lower brightness setting on the second display.

In an example, the method 500 may be repeated when updated brightness settings are received. Using the example above, initially, the first display may have had the higher brightness setting and the second display may have had the lower brightness setting. However, at a later time, the updated brightness setting of the second display may be set to be greater than the brightness setting of the first display. Thus, at the later time, the second display may have the higher brightness setting and the first display may have the lower brightness setting.

In response, the brightness setting of the BLU may be changed to be approximately equal to the updated brightness settings of the second display. The liquid crystals in the layer of liquid crystals of the second display may be oriented or rotated to allow a maximum amount of light from the BLU to pass through. The liquid crystals in the layer of liquid crystals of the first display may be rotated to allow a percentage of light that is emitted by the BLU to pass through. The percentage may be based on the brightness setting of the first display and the updated brightness setting of the second display.

For example, if the brightness setting of the first display is 400 nits and the updated brightness setting of the second display is 500 nits, then the percentage may be 80%. In other words, the liquid crystals may be rotated to allow 80% of the light to pass through. Conversely, the liquid crystals may be rotated to block 20% of the light from passing through. At block 512, the method 500 ends.

In an example, an electric current or electric field may be applied to the liquid crystals of the layer of liquid crystals of the first display and the second display to achieve a desired orientation. For example, a first electric current can be applied to the liquid crystals of the layer of liquid crystals of the first display to orient the liquid crystals to allow a percentage of light to pass through. A second electric current can be applied to the liquid crystals of the layer of liquid crystals of the first display to allow a maximum amount of light to pass through.

FIG. 6 illustrates an example of an apparatus 600. In an example, the apparatus 600 may be the apparatus 100. In an example, the apparatus 600 may include a processor 602 and a non-transitory computer-readable storage medium 604. The processor 602 may be a central processing unit (CPU), a graphical processing unit (GPU), an application specific integrated circuit (ASIC), and the like. Although a single processor 602 is illustrated in FIG. 6, it should be noted that multiple processors 602 may be deployed to execute the instructions stored in the non-transitory computer-readable storage medium 604 in a distributed computing environment.

In an example, the non-transitory computer-readable storage medium 604 may include a hard-disk drive, a random-access memory (RAM), a read-only memory (ROM), a solid state drive, and the like. The non-transitory computer-readable storage medium 604 may include instructions 606, 608, 610, and 612. The processor 602 may access the non-transitory computer-readable storage medium 604 to obtain the instructions 606, 608, 610, and 612. The processor 602 can then execute the instructions 606, 608, 610, and 612 to perform various functions.

In an example, the instructions 606 may include instructions to set a backlight unit to a first brightness level associated with a first display panel having a higher brightness setting, wherein the backlight unit is to provide backlight to the first display panel and a second display panel of a dual-sided display. The instructions 608 may include instructions to calculate a second brightness level associated with the second display panel having a lower brightness setting. The instructions 610 may include instructions to calculate an amount of rotation of liquid crystals in a layer of liquid crystals of the second display panel. The instructions 612 may include instructions to set the liquid crystals in the layer of liquid crystals in accordance with the amount of rotation calculated in the instructions to calculate.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A display comprising:
a backlight unit (BLU), wherein the BLU comprises a first side and a second side;
a first display panel coupled to the first side of the BLU, wherein the first display panel comprises a first layer of liquid crystals;
a second display panel coupled to the second side of the BLU, wherein the second display panel comprises a second layer of liquid crystals; and
a controller to:
set the BLU to a brightness level associated with a first brightness setting of the first display panel; and
control the second layer of liquid crystals to set a second brightness setting of the second display panel, wherein the second brightness setting is less than the first brightness setting.

2. The display of claim 1, wherein the BLU comprises:
a plurality of light emitting diodes; and
a light guide to scatter light emitted by the plurality of light emitting diodes towards the first display panel and the second display panel.

3. The display of claim 1, wherein the controller is communicatively coupled to a first brightness control interface of the first display panel and a second brightness control interface of the second display panel.

4. The display of claim 3, wherein a brightness setting of the first display panel is received by the first brightness control interface and a brightness setting of the second display panel is received by the second brightness control interface.

5. The display of claim 1, further comprising:
a power source operated in a pulse width modulation to power the BLU.

6. A method, comprising:
receiving, by a processor, a first brightness setting for a first display of a dual-sided display;
receiving, by the processor, a second brightness setting for a second display of the dual-sided display;
setting, via the processor, a brightness of a backlight unit of the dual-sided display to a level associated with a higher brightness setting between the first brightness setting and the second brightness setting; and
controlling, via the processor, a layer of liquid crystals of the first display or the second display with a lower brightness setting between the first brightness setting and the second brightness setting.

7. The method of claim 6, wherein the controlling comprises causing rotation of liquid crystals in the layer of liquid crystals to allow a desired amount of light to pass through based on the lower brightness setting.

8. The method of claim 7, wherein the amount by which the liquid crystals are rotated is based on a percentage calculated from the lower brightness setting and the higher brightness setting.

9. The method of claim 6, wherein the brightness of the backlight unit is controlled via pulse width modulation.

10. The method of claim 6, further comprising:
comparing, by the processor, the first brightness setting and the second brightness setting to determine the higher brightness setting and the lower brightness setting.

11. A non-transitory computer-readable storage medium encoded with instructions executable by a processor, the non-transitory computer-readable storage medium comprising:
instructions to set a backlight unit to a first brightness level associated with a first display panel having a higher brightness setting, wherein the backlight unit is to provide backlight to the first display panel and a second display panel of a dual-sided display;
instructions to calculate a second brightness level associated with the second display panel having a lower brightness setting;
instructions to calculate an amount of rotation of liquid crystals in a layer of liquid crystals of the second display panel; and
instructions to set the liquid crystals in the layer of liquid crystals in accordance with the amount of rotation calculated in the instructions to calculate.

12. The non-transitory computer-readable storage medium of claim 11, further comprising:
instructions to set liquid crystals in a layer of liquid crystals of the first display panel to an orientation that allows a maximum amount of light to pass through the layer of liquid crystals of the first display panel.

13. The non-transitory computer-readable storage medium of claim 11, wherein the backlight unit is controlled via a power source operated in a pulse width modulation.

14. The non-transitory computer-readable storage medium of claim 11, further comprising:
instructions to receive an updated brightness setting of the second display panel, wherein the updated brightness setting is greater than a current brightness setting of the first display panel;
instructions to set the backlight unit to a second brightness level associated with the updated brightness setting;
instructions to set the liquid crystals in the layer of liquid crystals of the second display panel to a full on position; and
instructions to rotate liquid crystals in a layer of liquid crystals of the first display panel to allow a percentage of light emitted by the backlight unit to pass through, wherein the percentage is based on the current brightness setting of the first display panel and the updated brightness setting of the second display panel.

15. The non-transitory computer-readable storage medium of claim 11, wherein the higher brightness setting of the first display panel and the second brightness level of the second display panel are set via a brightness control interface of the first display panel and the second display panel, respectively.
